(19) United States
(12) Patent Application Publication
(10) Pub. No.: US 2008/0073542 A1
(43) Pub. Date: Mar. 27, 2008

(54) Light guide having a tapered geometrical configuration for improving light collection in a radiation detector

(76) Inventor: Stefan Siegel, Knoxville, TN (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/525,347

(22) Filed: Sep. 22, 2006

(51) Int. Cl. G01T 1/20

(52) U.S. Cl. 250/368

(57) ABSTRACT

A radiation detector having a light guide with a plurality of light pipes is provided designed to improve light collection for reading out a larger scintillator array surface area than a photodetector assembly surface area. The light guide has a trapezoidal geometrical configuration and is symmetrical with respect to at least one axis thereof.

### BACKGROUND

1. Technical Field

The present disclosure generally relates to radiation detection and measurement, and especially to the field of imaging using scintillators and position sensitive photodetectors as used in conventional nuclear medicine cameras, such as positron emission tomography (PET) systems or other imaging devices requiring pixilated element readout. In particular, the present disclosure relates to a light guide having a tapered geometrical configuration which improves light collection in a radiation detector.

2. Background of Related Art

Nuclear medicine is a unique medical specialty wherein radiation is used to acquire images which show the function and anatomy of organs, bones or tissues of the body. Radiopharmaceuticals are introduced into the body, either by injection or ingestion, and are attracted to specific organs, bones or tissues of interest. Such radiopharmaceuticals produce gamma photon emissions which emanate from the body and are detected by a radiation detector, such as a positron emission tomography (PET) camera.

Conventional PET cameras utilize a scintillation crystal (usually made of lutetium oxyorthosilicate (LSO) or lanthanum bromide (LaBr)) which absorbs the gamma photon emissions and emits light photons (or light events) in response to the gamma absorption. An array of photodetectors, such as photomultiplier tubes, is positioned adjacent to the scintillation crystal. The photomultiplier tubes receive the light photons from the scintillation crystal and produce electrical signals having amplitudes corresponding to the amount of light photons received. The electrical signals from the photomultiplier tubes are applied to position computing circuitry, wherein the location of the light event is determined, and the event location is then stored in a memory, from which an image of the radiation field can be displayed or printed.

FIG. 1 illustrates a PET camera detector 10 comprising an array of scintillation crystals 12. Generally, the surface area of the scintillation crystal array is large enough (10×10 cm) to image a significant part of the human body. An array of photodetectors 13, such as an array of photo-multiplier tubes (PMTs) having a plurality of PMTs 14, views the scintillation crystal array surface area, to give positional sensitivity. Each PMT 14 has an X and a Y coordinate. When a photon is absorbed by a scintillation crystal 12, light energy is generated in the form of visible light. A number of PMTs 14 receive the light via a respective light guide 16 and produce signals.

The X and Y coordinates of the event are determined by associated circuitry 18 using as a main parameter the strength of the signals generated by each PMT 14. The energy of the event is proportional to the sum of the signals, called the Z signal. Only Z signals within a given range are counted. A housing 20 surrounds the scintillation crystal array, the array of photodetectors 13 and associated circuitry 18 to minimize background radiation. As shown by FIG. 2, a glass 24 is generally placed between the scintillation crystal array and the array of photodetectors 13 to spread the light amongst the PMTs 14.

Some PET radiation detectors utilize multi-channel or position-sensitive PMTs (PS-PMTs) instead of the conventional single channel PMTs described above. PS-PMTs allow the determination of scintillator crystal interaction without having to share the light photons across several PMTs. However, PS-PMTs tend to be more expensive than conventional single channel PMTs. They also increase the number of electronics channels one may potentially need to read out the signals unless a multiplexing scheme is utilized. Also, in order to cover a large area of scintillation material, more PS-PMTs need to be used, thereby increasing the cost of a PET camera. Although, only PS-PMTs are discussed here, one skilled in the art may also be aware of other position sensitive photodetectors, such as position-sensitive avalanche photodiodes (PS-APDs) which are even smaller.

One solution in the prior art as shown and described by U.S. Pat. No. 6,552,348 B2 is to place at least one optic taper acting as a light guide between the scintillation crystal array and the PMTs for altering the light response function of the scintillation crystals. A seemingly large taper may be used to create a larger imaging area and thus, enable a larger detection element area of the photodetector to be read out. However, this method, causes the absorption of the light photons by the light absorbing taper and therefore, degrades the energy resolution of the radiation detector.

Further, the taper typically involves fused optical elements or light pipes with their concomitant loss in light collection due to index of refraction mismatches and the fact that the light pipes are tapered violate their optic principles due to lack of parallelism of the clad(s). Also, the one-for-one coupling of light guides per scintillator element or crystal can be prohibitive in manufacture and often results in poor surface matching, in terms of surface area, for light collection from the scintillator array. Additionally, the cost of an optic taper becomes much more expensive as the volume/mass of the optic taper increases.

An optic taper generally includes a geometrical shape having two parallel surfaces and a plurality of tapered (non-parallel) light pipes extending there through. The plurality of tapered light pipes are typically arranged in a plurality of light pipe bundles. The tapered light pipes can be made from glass, plastics or other material having optical properties. An example of an optic taper is shown by FIG. 3 and designated generally by reference numeral 300. As shown by FIG. 3, the radius or cross-section of the taper 300 increases from top to bottom, and the taper 300 is sliced or cut at location A to provide a flat surface 304 which is opposite flat surface 306 (it is noted that surfaces 304, 306 can and do not have to be parallel). The two surfaces 304, 306 are parallel to each other. A plurality of tapered light pipes 308 extend between the two surfaces 304, 306. Thus, the optic taper 300 is characterized as having a plurality of tapered or non-parallel light pipes.

A need therefore exists to provide a light guide which does not include fused light pipes and has a tapered geometrical configuration for improving light collection in a radiation detector, such as a PET camera.

### SUMMARY

It is an aspect of the present disclosure to provide a light guide having a tapered geometrical configuration which does not include fused optical elements or light pipes and improves light collection in a radiation detector. A further aspect of the present disclosure is to provide a radiation detector having a light guide which yields improved image quality due to coupling a surface area of a scintillator array to a smaller surface area of the light guide and photodetector surface area, thereby enabling the read out of more scintillator elements or crystals per photodetector surface area.

In accordance with the above-noted aspects of the present disclosure, a light guide and a radiation detector having the light guide are presented. The light guide enables the read out of more scintillator elements or crystals per photodetector surface area of the radiation detector by coupling a surface area of a scintillator array to a smaller surface area of the light guide and photodetector surface area. In particular, the light guide is suitable for use with arrays of discrete photosensors.

Specifically, the present disclosure presents a radiation detector, such as a positron emission tomography (PET) camera, having a light guide with a tapered geometrical configuration which improves light collection in the radiation detector. The light guide is made from plastic, glass and/or silica optical elements or light pipes, or other optical materials. Each individual optical light pipe is in optical communication with a plurality of scintillator elements or crystals of a scintillator array for enabling the read out of more scintillator elements or crystals per photodetector surface area. In particular, the light guide of the present disclosure preferably optically couples in a 9:4 manner. This means that a 3×3 array of scintillator elements or crystals are coupled to a 2×2 array of light guide elements or light pipes.

In accordance with an embodiment of the present disclosure, the light guide includes a plurality of light pipes configured to optically communicate with scintillator elements or crystals of a scintillator array. The light guide has a tapered geometrical configuration and a trapezoidal geometric shape. The trapezoidal geometric shape includes a bottom square surface and a top square surface adjoined to each other by four trapezoid sides defining four equidistant, angled edges. Each of the plurality of light pipes includes a first end flush with the bottom square surface and a second end flush with the top square surface. The light guide enables the read out of more scintillator crystals per photodetector surface area. It is noted that the bottom and top surfaces do not have to be square-shaped.

According to another embodiment of the present disclosure, a radiation detector, such as a PET camera, is presented for detecting gamma photon emissions and generating electrical energy. The radiation detector includes an array of photodetectors and associated circuitry for detecting and converting light energy to electrical energy, a plurality of scintillation crystals positioned in proximity to the array of photodetectors for detecting gamma photon emissions and generating the light energy, and a light guide having a plurality of light pipes optically coupling the plurality of scintillation crystals with the array of photodetectors, where the light guide has a tapered geometrical configuration and a trapezoidal geometric shape. The trapezoidal geometric shape includes a bottom square surface and a top square surface adjoined to each other by four trapezoid sides defining four equidistant, angled edges. Each of the plurality of light pipes includes a first end flush with the bottom square surface and a second end flush with the top square surface.

### BRIEF DESCRIPTION OF THE DRAWINGS

The disclosure will become more clearly understood from the following detailed description in connection with the accompanying drawings, in which:

FIG. 1 is a schematic illustration of a prior art radiation detector;

FIG. 2 is a schematic illustration showing gamma ray interactions with a scintillation crystal of a prior art radiation detector;

FIG. 3 is a schematic illustration of an optic taper according to the prior art;

FIG. 4 is a side, schematic illustration of a radiation detector in accordance with an embodiment of the present disclosure;

FIG. 5 is a perspective view of a light guide illustrating a plurality of light pipes in accordance with the present disclosure;

FIG. 6 is a schematic bottom view of the light guide shown by FIG. 5 illustrating the plurality of light pipes;

FIG. 7 is a schematic top view of the light guide shown by FIG. 5 illustrating the plurality of light pipes;

FIGS. 8a and 8b are schematic side views of the light guide shown by FIG. 5 showing respective distance and angular measurements; and

FIGS. 9a, 9b and 9c are enlarged views of the area of details shown by FIGS. 6 and 7.

### DETAILED DESCRIPTION

The following description is presented to enable one of ordinary skill in the art to make and use the disclosure and is provided in the context of a patent application and its requirements. Various modifications to the disclosed embodiments will be readily apparent to those skilled in the art and the generic principles herein may be applied to other embodiments. Thus, the present disclosure is not intended to be limited to the embodiments shown but is to be accorded the broadest scope consistent with the principles and features described herein.

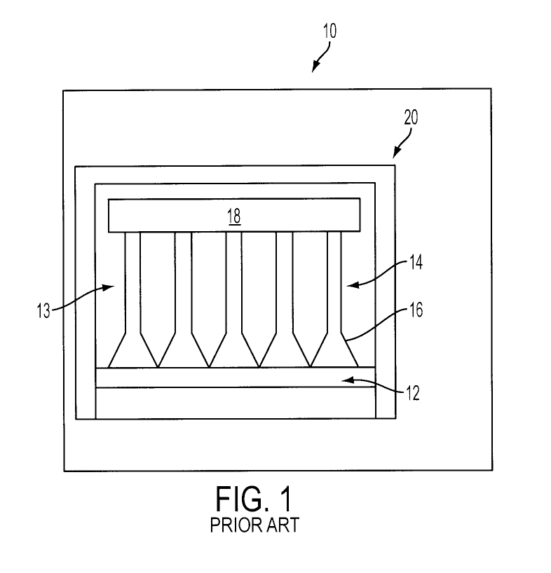

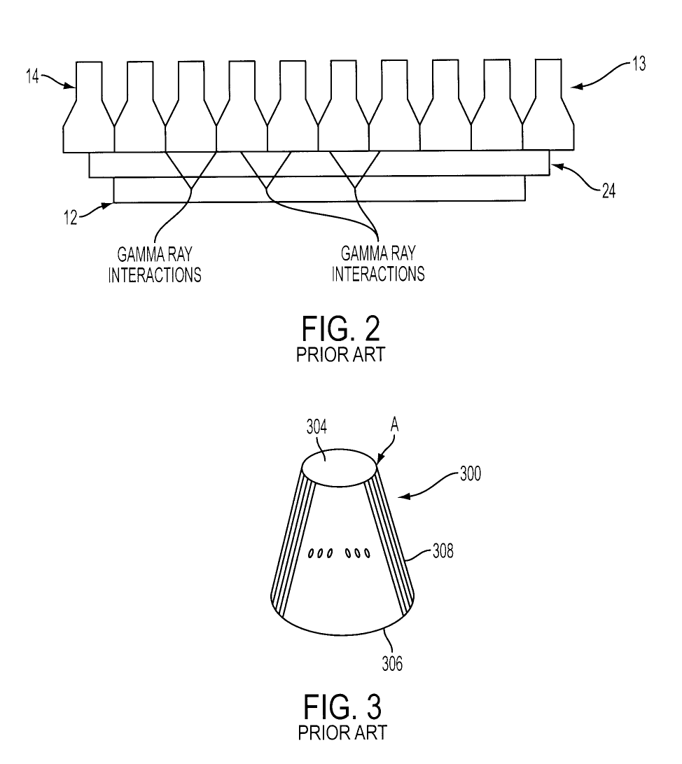

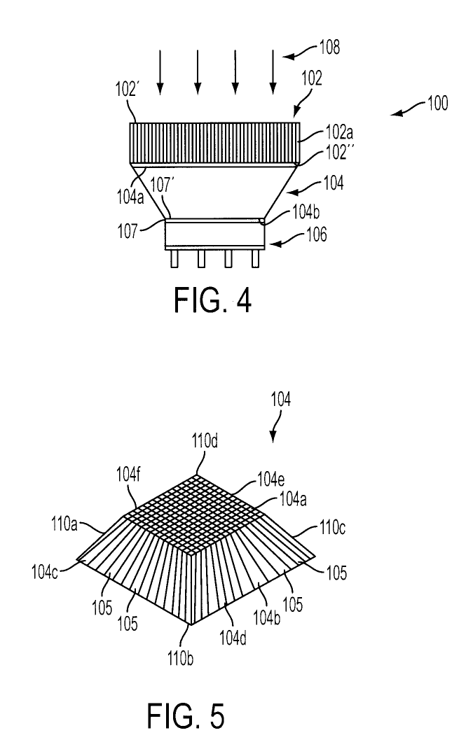

Referring now to the drawings, and initially to FIG. 4, there is shown a side, schematic illustration of a radiation detector in accordance with the present disclosure and generally referenced by numeral 100. The radiation detector 100 can be a positron emission tomography (PET) camera and includes a scintillator array 102 having a plurality of scintillator crystals or elements 102a, a light guide 104 (see FIGS. 5-9c) having a plurality of optical elements or light pipes 105, and a position-sensitive photodetector assembly 106 having components as known in the art (such as the components described above with reference to FIGS. 1 and 2). The light guide 104 does not include fused optical elements or light pipes and increases the detection surface area of the radiation detector 100 relative to the surface area of the position-sensitive photodetector assembly 106.

The scintillator array 102, as known in the art, is at least partially used for detecting and absorbing gamma photon radiation emissions 108 emanating from the body and directing the photons from one end 102′ of the array 102 to an opposite end 102″ of the array 102. Types of scintillator elements 102a that can be used in the scintillator array 102 include inorganic crystals, organic plastics, organic liquids and organic crystals. Preferably, the elements 102a of the scintillation array 102 are made from high light yield scintillators, such as lutetium oxyorthosilicate (LSO) or lanthanum bromide (LaBr).

End 102″ of the scintillator array 102 is positioned in proximity to and preferably in contact with bottom square surface 104a of the light guide 104. A top square surface 104b of the light guide 104 is positioned in proximity to and preferably in contact with the photodetector assembly 106 for transferring photons from the scintillator array 102 to the photodetector assembly 106. Top square surface 104b is preferably in contact with a glass entrance window 107 of the photodetector assembly 106.

As shown by FIGS. 5-8, the light guide 104 includes a plurality of glass, plastic and/or silica light pipes 105. The light pipes 105 can also be made from other optical materials, besides glass, plastic and silica. The light pipes 105 transfer light photons from the bottom square surface 104a to the top square surface 104b of the light guide 104. A group of light pipes 105 can be bundled together to form a light pipe bundle, such that the light guide 104 includes a plurality of light pipe bundles packed together to form a particular geometrical configuration of the light guide 104.

In particular, the light guide 104 has a tapered geometrical configuration and a trapezoidal geometric shape. The trapezoidal geometric shape includes the bottom square surface 104a and the top square surface 104b adjoined to each other by four trapezoid sides 104c-f defining four equidistant, angled edges 110a-d.

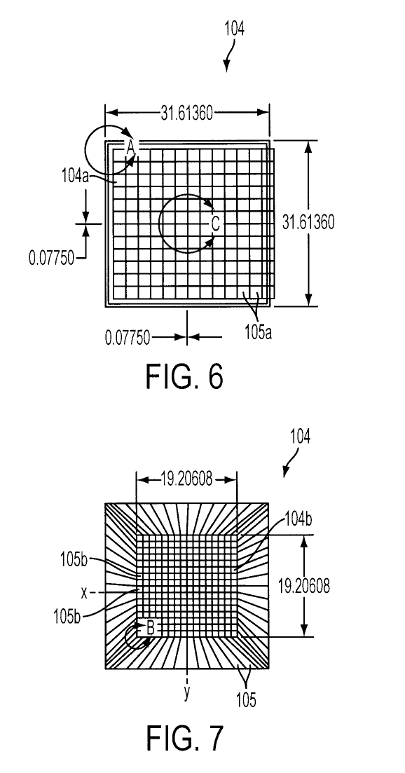

Each of the plurality of light pipes 105 includes a first end 105a flush with the bottom square surface 104a (FIG. 6) and a second end 105b flush with the top square surface 104b (FIG. 7). The first end 105a of each optical light pipe 105 is configured for being optically coupled with a plurality of scintillator elements or crystals 102a of the scintillator array 102. The second end 105b of each optical light pipe 105 is configured for being optically coupled with the photodetector assembly 106.

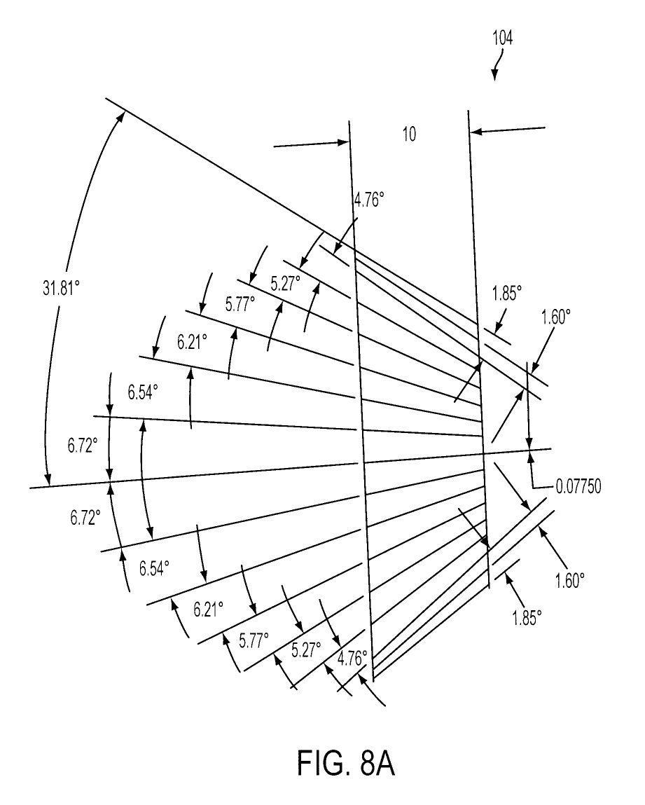

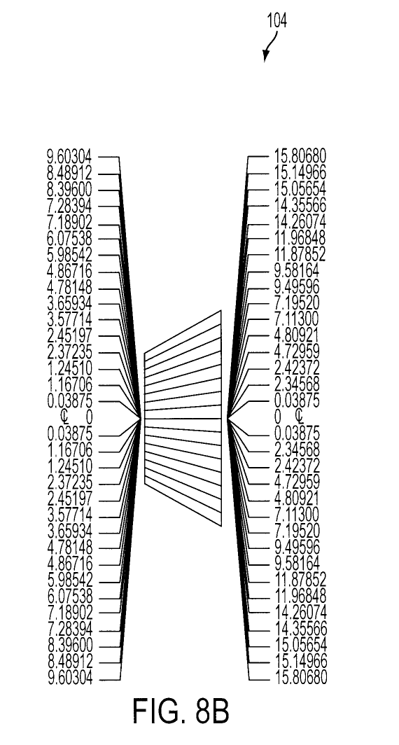

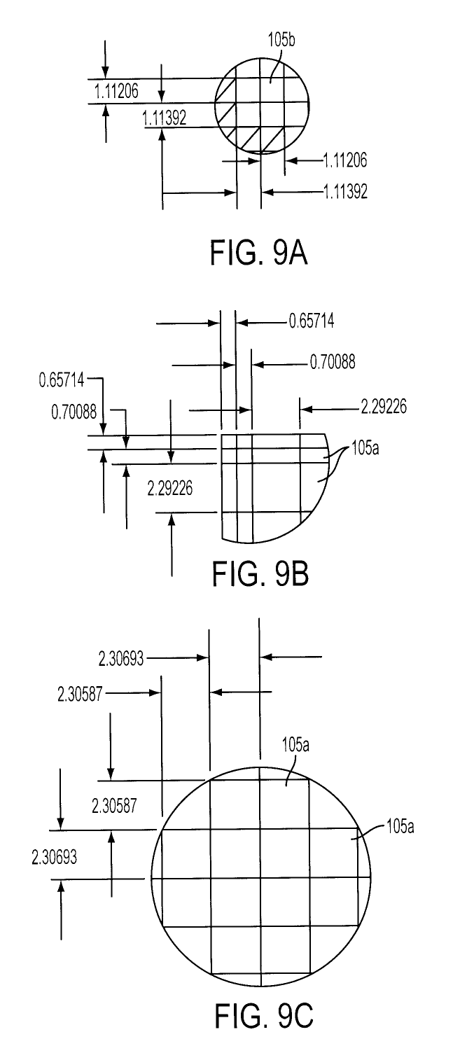

In a preferred embodiment as shown by FIGS. 6-9c (the measurements shown are in millimeters and degrees (FIG. 8a only)), each of the second ends 105b flush with the top square surface 104b has a square-shaped cross-section (see FIG. 9a which is an enlarged view of area B in FIG. 7). A majority of the first ends 105a flush with the bottom square surface 104a have a square-shaped cross-section (see FIG. 9c which is an enlarged view of area C in FIG. 6). Several of the first ends 105a flush with the bottom square surface 104a and located along the periphery of the bottom square surface 104a have a rectangular-shaped cross-section (see FIG. 9b which is an enlarged view of area A in FIG. 6). In the preferred embodiment, the top square surface 104b has a surface area of 368.87351 square millimeters and the bottom square surface 104a has a surface area of 999.10357 square millimeters.

The light guide 104 is symmetrical with respect to at least one axis thereof, such as along the X-axis and Y-axis shown by FIG. 7, as well as with respect to each of its diagonal axes. Accordingly, the measurements shown by FIG. 9a are representative of each corner of the top square surface 104b; and the measurements shown by FIG. 9b are representative of each corner of the bottom square surface 104a.

FIG. 8a illustrates the angular measurements of the sixteen light pipes 105 flush with a side (e.g., side 104c) of the light guide 104. All the sides 104c-f are identical with respect to the layout of the light pipes 105 thereat, such that the side shown by FIG. 8a is representative of all the sides 104c-f. FIG. 8b illustrates the distance measurements from the center of the bottom square surface 104a and the top square surface 104b to each of the first and second ends 105a, 105b of the light pipes 105.

When the light guide 104 is positioned in the radiation detector 100 as shown by FIG. 4, the first end 105a of each optical light pipe 105 is optically coupled to a plurality of scintillator elements 102a for enabling the light guide 104 to read out of more scintillator elements or crystals per photodetector surface area. The second end 105b of each optical light pipe 105 is optically coupled to the photodetector assembly 106. In particular, during operation of the radiation detector 100, gamma photon radiation emissions 108 propagate through the scintillator crystals 102a and individual light pipes 105 of the light guide 104 before being directed to the photodetector assembly 106. In the radiation detector embodiment illustrated by FIG. 4, the light guide 104 allows the detection of the scintillator array 102 that is significantly larger than the active surface area 107′ of the photodetector assembly 106.

The tapering down from the scintillator array surface area to a smaller photodetector surface area using the light guide 104 enables the tiling of photodectors into larger detecting surfaces. For example, the light guide 104 can be used to read out 400 pixels (20×20) on a single photosensor. Labeling such a device as a “detector”, one may subsequently tile four of these detectors into a 1×4 array to form a pixel surface composed of 20×80 elements of common pitch, or into a 2×2 array for 40×40 elements of common pitch.

In particular, a preferred embodiment of the light guide 104 optically couples in a 9:4 manner. This means that a 3×3 array of scintillator elements or crystals 102a are coupled to a 2×2 array of light guide elements or light pipes 105.

As described above, the light guide 104 according to the present disclosure does not include fused light pipes, has a tapered geometrical configuration and improves light collection in a radiation detector for reading out a scintillator array having a significantly larger surface area than the active surface area of a photodetector assembly.

Although the present disclosure has been described in accordance with the embodiments shown, one of ordinary skill in the art will readily recognize that there could be variations to the embodiment and these variations would be within the spirit and scope of the present disclosure. Accordingly, many modifications may be made by one of ordinary skill in the art without departing from the spirit and scope of the appended claims.

What is claimed is:

1. A radiation detector comprising:
a scintillator array having a plurality of scintillator elements;
a light guide having a trapezoidal geometric shape defining a top square surface and a bottom square surface, said light guide further having a plurality of light pipes each having a first end flush with the top square surface and a bottom end flush with the bottom square surface, the bottom square surface being positioned in proximity to the scintillator array; and
a photodetector assembly positioned in proximity to the top square surface of the light guide.

2. The radiation detector according to claim 1, wherein the light guide is symmetrical with respect to at least one axis thereof.

3. The radiation detector according to claim 1, wherein the geometrical configuration of the light guide is trapezoidal.

4. The radiation detector according to claim 1, wherein the light guide is manufactured from materials selected from the group consisting of plastic, glass and silica.

5. The radiation detector according to claim 1, wherein the scintillation array is made from one of lutetium oxyorthosilicate (LSO) or lanthanum bromide (LaBr).

6. The radiation detector according to claim 1, wherein the plurality of light pipes of the light guide are configured for transferring photons from the bottom square surface to the top square surface.

7. The radiation detector according to claim 6, wherein the plurality of light pipes of the light guide are manufactured from materials selected from the group consisting of plastic, glass and silica.

8. The radiation detector according to claim 1, wherein the top square surface of the light guide contacts a glass of the photodetector assembly.

9. The radiation detector according to claim 1, wherein the cross-section of the first ends is square-shaped, and the cross-section of the second ends is one of rectangular and square-shaped.

10. A light guide for a radiation detector, said light guide comprising:
a trapezoidal geometrical configuration defining a top square surface and a bottom square surface; and
a plurality of light pipes optically communicating the top square surface with the bottom square surface, each of the plurality of light pipes having a first end flush with the top square surface and a second end flush with the bottom square surface.

11. The light guide according to claim 10, wherein the bottom square surface of the light guide is configured for being positioned in proximity to a scintillator array of the radiation detector.

12. The light guide according to claim 10, wherein the light guide is symmetrical with respect to at least one axis thereof.

13. The light guide according to claim 10, wherein the cross-section of the first ends is square-shaped, and the cross-section of the second ends is one of rectangular and square-shaped.

14. The light guide according to claim 10, wherein the light guide is manufactured from materials selected from the group consisting of plastic, glass and silica.

15. The light guide according to claim 12, wherein the scintillation array is made from one of lutetium oxyorthosilicate (LSO) or lanthanum bromide (LaBr).

16. The light guide according to claim 10, wherein the plurality of light pipes are manufactured from materials selected from the group consisting of plastic, glass and silica.

17. The light guide according to claim 10, wherein the top square surface is configured for being positioned in proximity to a glass of a photodetector assembly of the radiation detector.

18. The light guide according to claim 10, wherein the trapezoidal geometrical configuration further defines four sides having a trapezoidal shape.

19. The light guide according to claim 10, wherein the first ends are configured for optically coupling with a plurality of scintillator array elements of the radiation detector.

20. The light guide according to claim 10, wherein the seconds ends are configured for optically coupling with a photodector assembly of the radiation detector.
